(19) United States
(12) Patent Application Publication
(10) Pub. No.: US 2011/0014363 A1
(43) Pub. Date: Jan. 20, 2011

(54) APPARATUS AND METHOD FOR MANUFACTURING MAGNETIC RECORDING MEDIUM

(75) Inventor: Satoru Ueno, Chiba-shi (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Minato-ku, Tokyo (JP)

(21) Appl. No.: 12/867,715

(22) PCT Filed: Feb. 26, 2009
(86) PCT No.: PCT/JP2009/053588

§ 371 Date: Aug. 13, 2010

(30) Foreign Application Priority Data
Feb. 27, 2008 (JP) 2008-046459 2008
Feb. 28, 2008 (JP) 2008-047283 2008

(51) Int. Cl. B05D 5/12; B05C 13/02

(52) U.S. Cl. 427/128; 118/500

(57) ABSTRACT

An apparatus for manufacturing a magnetic recording medium is provided. The apparatus has a plurality of connected film forming chambers; a carrier for holding a substrate; a mechanism for placing the substrate on the carrier prior to forming a film; a mechanism for sequentially transferring the carriers into the connected film forming chambers; and a mechanism for removing the substrate from the carrier after the film is formed. The mechanism for transferring the carrier is a linear motor. Furthermore, a method for manufacturing the magnetic recording medium by using such apparatus is also provided.

### TECHNICAL FIELD

The present invention relates to an apparatus and method for manufacturing a magnetic recording medium used in a hard disk device or the like, and more specifically, relates to a transporting device for a carrier, which holds a substrate, of an in-line type magnetic recording medium manufacturing apparatus.

Priority is claimed on Japanese Patent Application No. 2008-046459 filed Feb. 27, 2008 and Japanese Patent Application No. 2008-047283 filed Feb. 28, 2008, the contents of which are incorporated herein by reference.

### BACKGROUND ART

In recent years, recording density has significantly improved in the area of magnetic recording media used in a hard disk device or the like, and in particular, recording density is recently continuing to grow at a phenomenal rate, approximately 100 times in ten years.

As illustrated in FIG. 1, a magnetic recording medium used in a hard disk device or the like includes a non-magnetic substrate 80, and a seed layer 81, an undercoat film 82, a magnetic recording film 83, a protective film 84, and a lubricant layer 85 laminated sequentially on both surfaces or one surface of the non-magnetic substrate 80. A magnetic recording medium having this type of configuration is manufactured by an in-line type film formation apparatus in general.

FIG. 2 is a schematic drawing showing an example of an in-line type magnetic recording medium manufacturing apparatus, FIG. 3 is a schematic drawing showing sputtering film formation chambers and carriers of the magnetic recording medium manufacturing apparatus, and FIG. 4 is a side view showing the carrier provided in the magnetic recording medium manufacturing apparatus of the present invention. In FIG. 3, the carrier indicated by the solid lines illustrates a state when the carrier is stopped at a first film formation position, whereas the carrier indicated by the dashed lines represents the state when the carrier is stopped at a second film formation position. In other words, in the sputtering film formation chambers illustrated for this example, two targets are positioned opposing the substrate within the chamber, and therefore film formation is first conducted onto the substrate on the left side of the carrier with the carrier stopped at the first film formation position, the carrier is subsequently moved to the position indicated by the dashed lines, and film formation is then conducted onto the substrate on the right side of the carrier with the carrier stopped at the second film formation position. In those cases where four targets are positioned opposing the substrates within the film formation chamber, this type of movement of the carrier becomes unnecessary, and film formation onto the substrates supported on the left and right sides of the carrier can be conducted simultaneously.

As shown in FIG. 2, the in-line type magnetic recording medium manufacturing apparatus has, for example, a substrate cassette transferring robot base 1, a substrate cassette transferring robot 3, a substrate supplying robot chamber 2, a substrate supplying robot 34, a substrate installation chamber 52, corner chambers 4, 7, 14, and 17 for rotating the carriers, sputtering film formation chambers and substrate heating film formation chambers 5, 6, 8 to 13, 15, and 16, protective film formation chambers 18 to 20, a substrate removal chamber 54, a substrate removal robot chamber 22, a substrate removal robot 49, a carrier ashing chamber 3A, and a plurality of carriers 25 on which a plurality of film formation substrates (non-magnetic substrates) 23 and 24 are mounted.

A vacuum pump is connected to each of these chambers 2, 52, 4 to 20, 54, and 3A, and each of the carriers 25 is transported sequentially into each of the chambers, the insides of which are maintained in a reduced pressure state by operation of the vacuum pumps. By forming thin films (such as the seed layer 81, the undercoat layer 82, the magnetic recording film 83, and the protective film 84) on both surfaces of the carrier-mounted film formation substrates 23 and 24 inside each of the film formation chambers, a magnetic recording medium that represents one example of a thin film laminate can be obtained.

As illustrated in FIG. 4, the carrier 25 has a support base 26, and a plurality of substrate mounts 27 (two in the case of this embodiment) provided on the upper surface of the support base 26.

Each of the substrate mounts 27 is composed of a plate body 28 of substantially the same thickness as the substrates for film formation (the non-magnetic substrates) 23 and 24, in which there is formed a circular through hole 29 having a slightly larger diameter than the outer periphery of the film formation substrates 23 and 24, with a plurality of support members 30 projecting from the periphery of the through hole 29 towards the interior of the through hole 29. The film formation substrates 23 and 24 are fitted inside the through holes 29 of the substrate mounts 27, and the edges of the substrates engage with the support members 30, thereby supporting and holding the film formation substrates 23 and 24. These substrate mounts 27 are provided in alignment on the upper surface of the support base 26 so that the main surfaces of the two mounted film formation substrates 23 and 24 are not only substantially orthogonal relative to the upper surface of the support base 26, but are also positioned within substantially the same plane. In the following description, the two film formation substrates 23 and 24 mounted on the substrate mounts 27 are referred to as the first film formation substrate 23 and the second film formation substrate 24 respectively.

The substrate cassette transferring robot 3 supplies the film formation substrates 23 and 24 from a cassette, in which the substrates are housed, to the substrate installation chamber 2, and also extracts magnetic disks (namely, the film formation substrates 23 and 24 with each of the films 81 to 84 formed thereon) that have been removed in the substrate removal chamber 22. These substrate installation and removal chambers 2 and 22 each have an external opening on one side of the chamber, and doors 51 and 55 that open and close the opening.

Further, neighboring walls between each of the chambers 2, 52, 4 to 20, 54, and 3A are mutually interconnected, and a gate valve is provided within the connection between each pair of chambers, so that when these gate valves are closed, the inside of each chamber is an independently sealed space.

The corner chambers 4, 7, 14, and 17 are chambers used for altering the travel direction of the carrier 25, and each of these chambers is provided with a mechanism, not shown in the drawing, for rotating the carrier and transferring it to the next film formation chamber.

The protective film formation chambers 18 to 20 are chambers for forming a protective film, using a CVD method or the like, on the surface of the top layer formed on the first film formation substrate 23 and the second film formation substrate 24. A reactive gas supply tube and a vacuum pump, which are not illustrated in the drawing, are connected to each of the protective film formation chambers.

The reactive gas supply tube is provided with a valve, the opening and closing of which is controlled by a control mechanism not shown in the drawing, and a gate valve for the vacuum pump, the opening and closing of which is controlled by a control device not shown in the drawing, is provided between the vacuum pump and the protective film formation chamber. By controlling the opening and closing of this valve and the pump gate valve, the supply of gas from the sputtering gas supply tube, the pressure inside the protective film formation chamber, and gas evacuation of the interior of the chamber can be controlled.

In the substrate removal film formation chamber 54, the first film formation substrate 23 and the second film formation substrate 24 mounted on the carrier 25 are removed using the robot 49. Then, the carrier 25 is transported into the carrier ashing chamber 3A.

As a method of transporting a carrier in such an in-line type magnetic recording medium manufacturing apparatus, as disclosed in Patent Document 1 for example, there has been proposed a method that uses the magnetic attraction force of a magnet provided in a carrier and a magnet provided within a film formation apparatus. That is to say, as shown in FIG. 5A and FIG. 5B, a carrier 100 is held by a guide roller so as to move in a lateral direction parallel with the page surface, a magnet 300 is arranged in the lower section of the carrier 100 so that the N poles and S poles thereof are alternately positioned, a cylinder-shaped carrier driving magnet 200, in which N poles and S poles are arranged in a helical form, is provided thereunder, the magnet 300 of the lower section of the carrier and the carrier driving magnet 200 are magnetically bound in a non-contact manner, and the carrier driving magnet 200 is rotated about the cylinder center axis, to thereby move the carrier 100 in the lateral direction parallel with the page surface.

Patent Document 2 discloses use of a linear motor for improving the ability of a system to transport disk substrates.

Patent Document 1: Japanese Unexamined Patent Application, First Publication No. 2002-288888

Patent Document 2: Japanese Unexamined Patent Application, First Publication No. H08-335620

### DISCLOSURE OF INVENTION

### Problems to be Solved by the Invention

In the carrier transporting device disclosed in Patent Document 1, the carrier driving magnet for transporting a carrier is provided in the lower section of the carrier. In the transporting device disclosed in Patent Document 1, it is technically possible that a magnet be provided on the side section of the carrier, a carrier driving magnet be provided in a position opposing thereto, the carrier driving magnet and the magnet provided on the side section of the carrier be magnetically bound, and the carrier driving magnet be rotated, to thereby transport the carrier. However, in those cases where the carrier driving magnet is rotated in an upward direction with respect to the carrier surface, the carrier is lifted in the upward direction by the magnetic attraction force between both of the magnets and consequently the carrier vibrates substantially. Moreover, in those cases where the carrier driving magnet is rotated in a downward direction with respect to the carrier surface, the carrier is pushed against the bearing that supports the carrier and consequently the operation of the carrier is degraded.

In order to solve such problems, there may be considered a method in which the carrier is guided using bearings or the like so that the carrier will not move in the upward direction, and the number of bearings for the downward direction is increased. However, if the number of bearings that support the carrier increases, then the movement of the carrier will be degraded, and also degassing from the bearings will cause the level of vacuum in the film formation chamber to decrease. Moreover, it is preferable that a vacuum pump, which is a heavy object, be provided in the lower section of the film formation chamber. However, if a carrier driving magnet and a mechanism for rotating this magnet are provided in the lower section of the film formation chamber, then these components may cover the evacuation tube, and consequently gas evacuation of the interior of the film formation chamber performed by the vacuum pump will be obstructed. In addition, there is a demand for increasing the speed of carrier transportation in order to increase the manufacturing capacity of the magnetic recording medium manufacturing apparatus. However, in the mechanism disclosed in Patent Document 1, there is a limitation on the rotation speed of the carrier driving magnet and there is also a limitation on the speed of carrier transportation. Moreover, in this mechanism, it is necessary to support the carrier with bearings against falling under its own weight. However, use of a liquid lubricating agent for bearings to be used in a vacuum condition is difficult. Therefore, in those cases where a significant load is applied to the bearings, the rotation characteristic of the bearings is degraded and it is consequently difficult to move the carrier at high speed. Furthermore, the carrier driving magnet and the rotation mechanism thereof are preferably provided outside the film formation chamber in order to ensure a high level of vacuum inside the film formation chamber. However, the structure inside the film formation chamber will become complex if such configuration is to be realized, and it is difficult to ensure a high level of vacuum within the film formation chamber due to leakage from these mechanisms and the sealing portions thereof.

The present invention takes into consideration the above problems, with an object of providing a magnetic recording medium manufacturing apparatus that is capable of transporting carriers at high speed, has a high level of capacity of evacuating the interior of a film formation chamber, and is capable of easily realizing a high level of vacuum in a short period of time, in an in-line type magnetic recording medium manufacturing apparatus, and a magnetic recording medium manufacturing method that uses this apparatus.

### Means for Solving the Problem

Having earnestly conducted investigations in order to solve the above problems, the present inventors discovered that the above problems can be solved by using a linear motor for transporting carriers used in an in-line type magnetic recording medium manufacturing apparatus, and providing at least one member in the manufacturing apparatus that supports the carrier against falling under its own weight, and the inventors thus completed the present invention. In other words, the present invention relates to the aspects described below.

(1) A magnetic recording medium manufacturing apparatus having a plurality of connected film formation chambers, a carrier that holds a substrate, a mechanism for mounting a pre-film-formation substrate on the carrier, a mechanism for sequentially transporting the carrier into the plurality of connected film formation chambers, and a mechanism for removing a post-film-formation substrate from the carrier, characterized in that the mechanism for transporting the carrier is a linear motor.
(2) A magnetic recording medium manufacturing apparatus according to (1) above, wherein a magnetic material is provided on a side section of the carrier, and the carrier is transported by a linear motor that is provided on a wall section of the film formation chamber so as to oppose to the magnetic material.
(3) A magnetic recording medium manufacturing apparatus according to either one of (1) and (2) above, wherein the linear motor has a function of supporting the carrier against falling under its own weight, and a guide that supports the carrier against falling under its own weight is provided inside the film formation chamber.
(4) A magnetic recording medium manufacturing apparatus according to any one of (1) to (3) above, wherein the guide provided in the film formation chamber that supports the carrier against falling under its own weight is a plurality of bearings.
(5) A magnetic recording medium manufacturing apparatus according to any one of (1) to (4) above, wherein a force applied to each of the bearings is 0 or 9.8 N or less.
(6) A magnetic recording medium manufacturing apparatus according to any one of (1) to (5) above, wherein the magnetic material provided on the side section of the carrier is a permanent magnet.
(7) A magnetic recording medium manufacturing apparatus according to any one of (1) to (6) above, wherein an electromagnet of the linear motor is provided on an atmosphere side of the film formation chamber.
(8) A magnetic recording medium manufacturing method characterized in forming a least magnetic film on the surface of a substrate, using the magnetic recording medium manufacturing apparatus according to any one of (1) to (7) above.

### EFFECT OF THE INVENTION

According to the present invention, in the magnetic recording medium manufacturing apparatus, the speed of carrier transportation can be increased to a high speed, and therefore the capacity of manufacturing magnetic recording media can be increased. Moreover, since the capacity of evacuating the interior of the film formation chamber can be increased, it is possible, at a high speed, to perform introduction and evacuation of processing gas into and from the film formation chamber, and the film formation process of a magnetic recording medium can be smoothly performed, thereby increasing the capacity of manufacturing magnetic recording media. Furthermore, since a high level of vacuum in the film formation chamber can be easily ensured, it is possible to provide a method of manufacturing a high quality magnetic recording medium, and it is also possible to handle even higher level film formation techniques such as reactive sputtering.

### BRIEF DESCRIPTION OF THE DRAWINGS

FIG. 1 is a schematic longitudinal sectional view illustrating one example of a magnetic recording medium manufactured using the method for manufacturing a magnetic recording medium according to a conventional method or to the method of the present invention.

FIG. 2 is a schematic diagram illustrating an exterior view of the magnetic recording medium manufacturing apparatus of a conventional method or to the method of the present invention.

FIG. 3 is a schematic diagram illustrating sputtering film formation chambers and carriers provided in the magnetic recording medium manufacturing apparatus of the conventional method or to the method of the present invention.

FIG. 4 is a side view illustrating a carrier provided in the magnetic recording medium manufacturing apparatus according to the conventional example or to the present invention.

FIG. 5A is a schematic diagram illustrating a conventional carrier and the driving system thereof.

FIG. 5B is a cross-sectional view illustrating the conventional carrier shown in FIG. 5A and the driving system thereof.

FIG. 6 is a perspective view illustrating an example of a carrier of the present invention and the driving system thereof.

FIG. 7 is a perspective view illustrating the driving system of the present invention in FIG. 6.

FIG. 8 is a perspective view illustrating the driving system of the present invention in FIG. 7 in a state where a cover of the electromagnet is removed.

FIG. 9A is a front view illustrating the carrier of the present invention and the driving system thereof.

FIG. 9B is a cross-sectional view of the portion illustrated with the dashed line A in FIG. 9A.

FIG. 10A is an enlarged view illustrating a peripheral portion of a carrier and a guide that supports the carrier, as one embodiment of the present invention.

FIG. 10B is a cross-sectional view (that corresponds to the portion illustrated with the dashed line A in FIG. 9A) regarding FIG. 10A.

FIG. 11A is an enlarged view illustrating the peripheral portion of the carrier and a guide that supports the carrier, as another embodiment of the present invention.

FIG. 11B is a cross-sectional view (that corresponds to the portion illustrated with the dashed line A in FIG. 9A) regarding FIG. 11A.

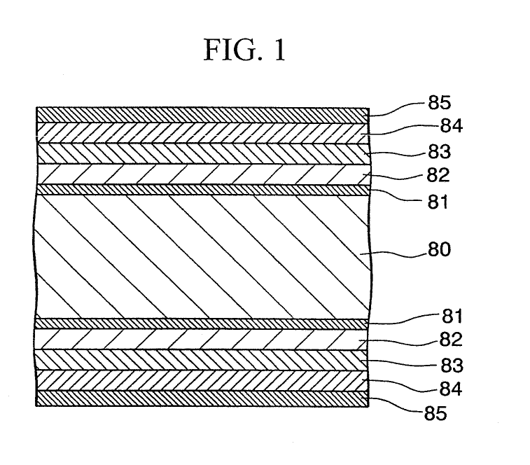

### DESCRIPTION OF REFERENCE SYMBOLS

1: Substrate cassette transferring robot base
2: Substrate supplying robot chamber
3: Substrate cassette transferring robot
3A: Carrier ashing chamber
4, 7, 14, 17: Corner chamber for rotating carrier
5, 6, 8 to 13, 15, 16: Sputtering film formation chamber and substrate heating film formation chamber
18 to 20: Protective film formation chamber
22: Substrate removal robot chamber
23, 24: Film formation substrate (non-magnetic substrate)
25: Carrier
26: Support base
27: Substrate mount
28: Plate body
29: Circular through-hole
30: Supporting member
34: Substrate supplying robot
49: Substrate removal robot
52: Substrate installation chamber
54: Substrate removal chamber
80: Non-magnetic substrate
81: Seed layer
82: Undercoat film
83: Magnetic recording film
84: Protective film
85: Lubricant layer
100: Carrier
200: Carrier driving magnet
300: Magnet
601: Carrier
602: Linear motor driving system
603: Side wall section of film formation chamber
604: Linear motor driving magnetic material
605: Transportation bearing
606: Bearing (guide)
701: Electromagnet cover
801: Linear motor driving electromagnet
901: Carrier lower section
903: Location where carrier and transportation bearing come in contact

### BEST MODE FOR CARRYING OUT THE INVENTION

A manufacturing apparatus of the magnetic recording medium of the present invention is characterized in that there is provided at least one member that supports a carrier against falling under its own weight. Here a linear motor serving as the driving system of the carrier, may be the member that supports the carrier against falling under its own weight, or instead of the linear motor, another member may serve as a member that supports the carrier against falling under its own weight. Hereunder, specific embodiments of the present invention are described, with reference to the drawings.

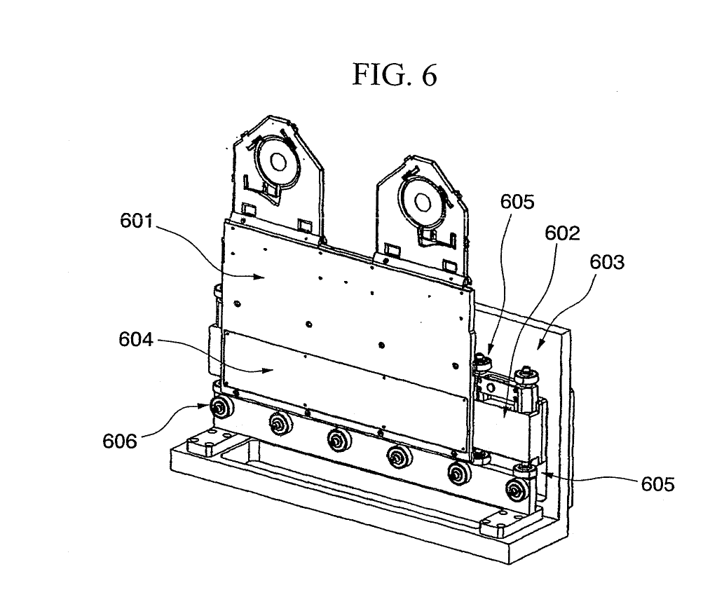

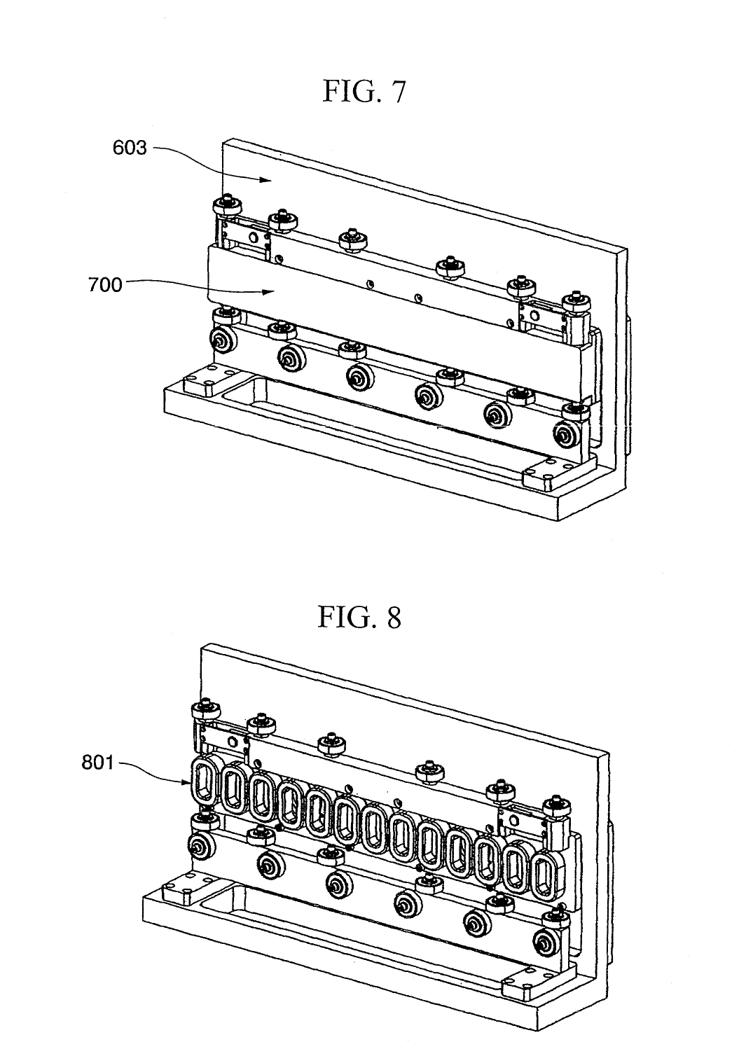

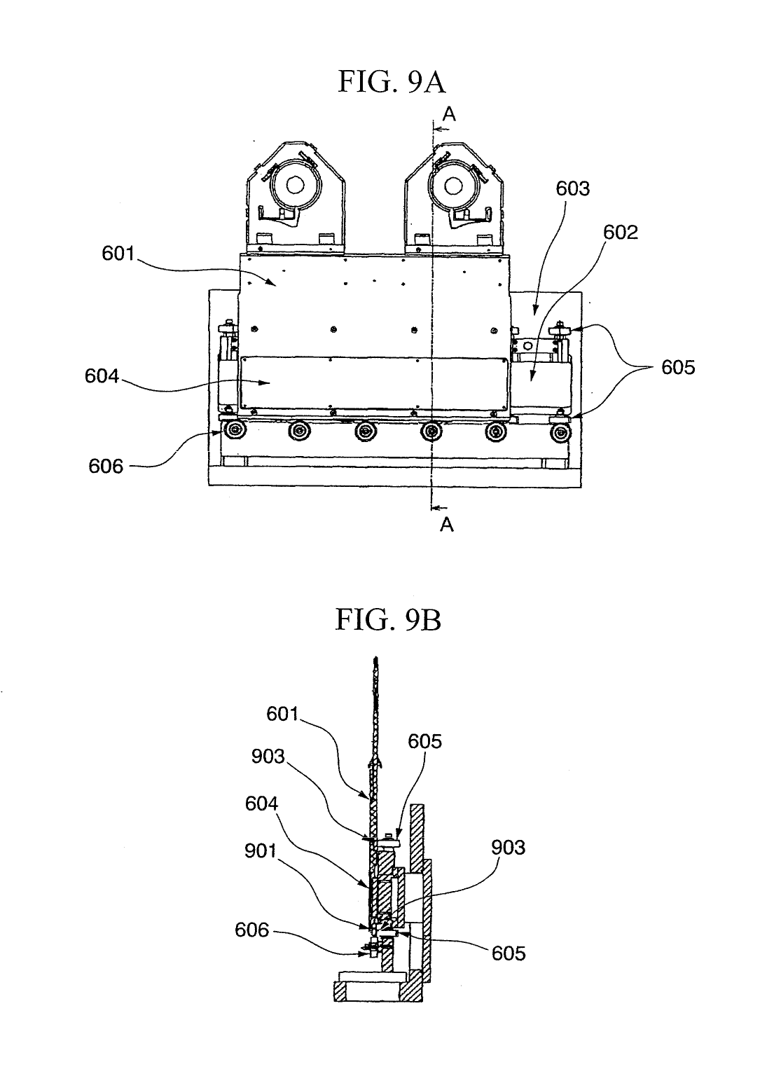

FIG. 6 is a perspective view schematically illustrating the carrier of the present invention and the driving system thereof. Moreover, FIG. 7 is a diagram in which the carrier is removed from the perspective view of FIG. 6. Furthermore, FIG. 8 is a diagram in which a vacuum cover is removed in FIG. 7, and a plurality of electromagnets serving as the driving system of the linear motor can be seen. FIG. 9A is a front view of the carrier illustrated in FIG. 6 and the driving system thereof. FIG. 9B is a cross-sectional view of the line A-A in FIG. 9A.

As illustrated in FIG. 6 and FIG. 7 and in FIG. 9A and FIG. 9B, a magnetic recording medium manufacturing apparatus of the present invention includes a carrier 601 that transports a substrate, and a linear motor driving system 602 that transports the carrier. Moreover, as a preferred embodiment of the present invention, in the magnetic recording medium manufacturing apparatus illustrated in each diagram, there are included a guide 606 that is provided in a film formation chamber. The linear motor driving system 602 of the present invention is provided on a side wall section 603 of the film formation chamber so as to transport a carrier in a lateral direction. Inside the linear motor driving system 602 there are provided a plurality of linear motor driving electromagnets 801, and in a position on the carrier 601 that opposes the linear motor driving system 602, there is provided a linear motor driving magnetic material 604.

In the manufacturing apparatus of the present invention, it is preferable that the magnetic material provided on the side surface or the like of the carrier 601 be attracted by the linear motor driving electromagnet 801 provided inside the linear motor driving system 602 so as to support the carrier against falling under its own weight. In this case, the linear motor functions as a member of the present invention that supports the carrier against falling under its own weight.

As illustrated in FIG. 6, in the present invention, for example, the carrier 601 is transported using the magnetic attraction force and/or magnetic repulsion force between the linear motor driving electromagnet 801 (refer to FIG. 8), which is divided into several pieces, and the linear motor driving magnetic material 604. However, there may be provided transporting bearings 605 so that the carrier 601 and the linear motor driving system 602 do not come in contact with each other. These transporting bearings 605 prevent the carrier 601 and the linear motor from coming into contact with each other, and moreover, the carrier can be moved in the lateral direction at a high speed by driving the linear motor.

In the present invention, by employing such a mechanism, it is possible to reduce the load on the guide (the plurality of provided bearings 606 in FIG. 6 correspond to the guide of the present invention) that support the carrier to the greatest possible extent, and the frictional force that the carrier receives from the guide is reduced to the greatest possible extent. Thereby, the carrier can be moved at a high speed.

In the present invention, as illustrated in FIG. 6, a plurality of bearings 606 are preferably used as a guide that supports the carrier provided in the film formation chamber, in terms of the sliding characteristic thereof. The term “bearing” here generally refers to a bearing that reduces friction in mechanical components, ensuring smooth mechanical rotational movement. However, in the present invention, it refers to a rolling bearing.

In the present invention, as illustrated in FIG. 6, the force to be applied to each of the bearings provided as the guide 606 that supports the carrier provided in the film formation chamber is preferably 0 or 9.8 N or less. In the transporting mechanism of the present invention, the carrier may not need to be supported by the guide and may be supported only by the linear motor. That is to say, in such a case, in a state where the carrier is not in contact with the guide 606, the force applied to the guide 606 is of course 0. However, if such a structure is employed, the carrier may vibrate in some cases while transporting the carrier. That is to say, the carrier 601 is supported only by the magnetic attraction force of the linear motor driving system 602 and the frictional force between the transporting bearings 605 and the carrier 601. However, in this type of situation, the carrier vibrates at a unique resonating frequency of the carrier. This vibration is a vibration of a comparatively low frequency. However, this may cause the substrate to fall from the carrier, or plasma and the like may become unstable and an adverse effect may arise in the process of forming a film on the substrate in some cases.

Therefore the “guide that supports the carrier” of the present invention refers to a member that that has at least one of either a function of steadily supporting the carrier against falling under its own weight while the carrier is being transported, and a function of preventing such vibrations occurring to the carrier. In those cases where the guide supporting the carrier has the function of steadily supporting the carrier against falling under its own weight, the guide functions as the member that supports the carrier of the present invention against falling under its own weight.

Specifically, in those cases where the force to be steadily applied to the guide 606 when the carrier is being transported or being on stand-by is 0, the “guide that supports the carrier” of the present invention has a function of preventing vibrations of the carrier, and serves to prevent the carrier falling off the substrate or prevent an adverse effect such as instability in plasma in the film formation process. On the other hand, in those cases where the force to be steadily applied to the guide 606 when the carrier is being transported or being on stand-by is not 0 (that is to say, if a predetermined force is steadily applied), the guide has not only the function of preventing vibrations of the carrier but also the function of steadily supporting the carrier against falling under its own weight while transporting the carrier, and the guide serves as a member that supports the carrier against falling under its own weight.

The “force to be steadily applied to the guide” does not refer to a temporal force that is applied when the carrier vibrates and the carrier comes into contact with the guide. It refers to a force that the guide receives from the carrier in a situation where the “force to be steadily applied to the guide” is 0 if the guide supporting the carrier does not have the function of substantially supporting the carrier against falling under its own weight, and if the guide has the function of substantially supporting the carrier against falling under its own weight, such function is exerted, when taking into consideration whether or not the guide is provided with the function of substantially supporting the carrier against falling under its own weight. For example, in those cases where the linear motor that drives the carrier is given a similar function of substantially supporting the carrier against falling under its own weight, and the carrier is substantially supported by the guide that supports the carrier and the magnetic attraction force of the linear motor, the “force steadily applied to the guide” means a value in which the magnetic attraction force is subtracted from the force to hold the carrier from falling under its own weight.

Hereunder, the relationship between the carrier and the guide that supports the carrier is described in detail.

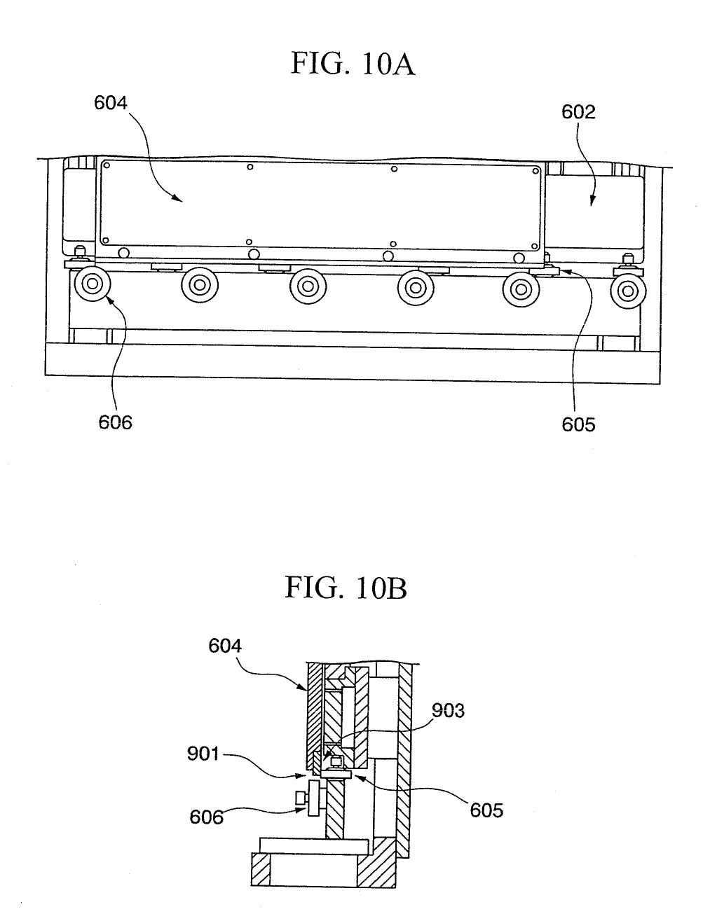

In the embodiment illustrated in FIG. 10A and FIG. 10B, the linear motor (the linear motor driving system 602, the linear motor driving magnetic material 604, and so forth) that drives the carrier 601 is given a function of completely supporting the carrier 601 against falling under its own weight. That is to say, in the present embodiment, only the linear motor constitutes the member that supports the carrier against falling under its own weight. A carrier lower section 901 and the bearings 606 provided thereunder are steadily not in contact with each other, and a constant clearance is provided between the carrier 601 and the bearings (guide) 606. In such a case, the bearings 606 are not for exerting the function of steadily supporting the carrier against falling under its own weight, but as described above, they serve as a member that primarily exerts the function of preventing incidental vibrations of the carrier that may occur when transporting the carrier.

Moreover, in the present embodiment, these bearings 606 serve as a member that prevents the carrier 601 from falling incidentally, and that, in addition, prevents the carrier 601 from departing from the braking range in the linear motor driving system when the carrier 601 vibrates significantly. Moreover, in a case or the like where braking on the carrier 601 performed by the linear motor accidentally becomes absent when the carrier 601 is transported, the bearings 605 may also have a function of supporting the carrier within the braking range until braking on the carrier performed by the linear motor has been restored. Furthermore, even in the normal state of carrier transportation performed by the linear motor, the carrier may vibrate significantly due to some causes, and the carrier may temporarily depart from the braking range of the linear motor in some cases. However, the bearings 605 also have a function of preventing the carrier from entering a state where it cannot be braked.

In the present embodiment, the clearance between the carrier 601 and the bearings (guide) 606 in a state where the carrier 601 and the bearings 606 are not in contact with each other (that is to say, in the normal state where they are not in contact with each other due to incidental vibrations), is not particularly limited as long as it has a structure as described above that can effectively prevent incidental vibrations occurring to the carrier. For example, in those cases where a carrier with approximately 40 cm width is used, the clearance between the carrier and the bearings (guide) 606 may be adjusted within a range of approximately 3 mm to 3 cm.

Moreover, in the example illustrated in FIG. 10A and FIG. 10B, the bearings 606 are provided as a member that exerts the function of preventing incidental vibrations of the carrier. However, the linear motor (the linear motor driving system 602, the linear motor driving magnetic material 604, and so forth) that serves as the driving system of the carrier completely performs the function of supporting the carrier against falling under its own weight. Therefore, in such a case, it is possible, without providing the bearings 606 that exert the function of preventing incidental vibrations of the carrier, to demonstrate the effects of the present invention such as; the speed of carrier transportation, the capacity of manufacturing magnetic recording media, and the capacity of evacuating the interior of the film formation chamber. However, in a general magnetic recording medium manufacturing apparatus, even in those cases where the linear motor and the like that serve as the driving system of the carrier are completely performing the function of supporting the carrier against falling under its own weight, it is preferable, in consideration of preventing accidents such as the carrier falling off due to incidental vibrations of the carrier, that bearings or the like that exert the function of preventing incidental vibrations of the carrier be provided.

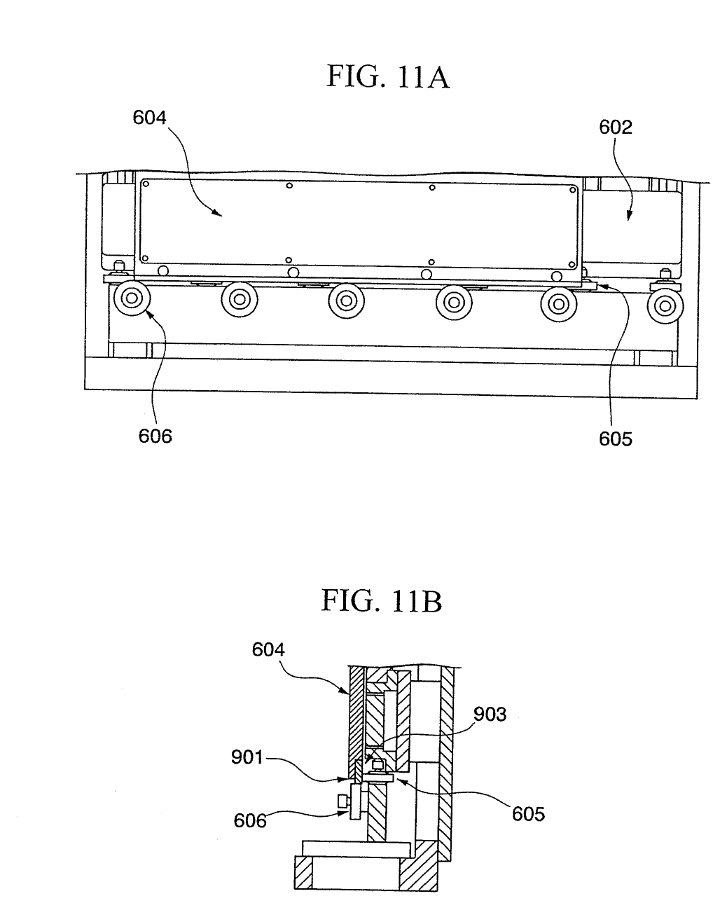

Next, the embodiment illustrated in FIG. 11A and FIG. 11B describes a case where the linear motor (the linear motor driving system 602, the linear motor driving magnetic material 604, and so forth) that serves as the driving system of the carrier 601, does not substantially support the carrier 601 against falling under its own weight, or serves part of the function of supporting the carrier 601 against falling under its own weight. That is to say, in the embodiment of FIG. 11A and FIG. 11B, the bearings (guide) 606 are provided so as to be in contact with the carrier 601, and the bearings (guide) 606 function as a member that supports the carrier 601 against falling under its own weight. In the present embodiment, in those cases where the linear motor serves part of the function of supporting the carrier 601 against falling under its own weight, the remaining functions are to be performed by the bearings (guide) 606. Therefore, in these cases, the linear motor and the bearings (guide) constitute the member that supports the carrier against falling under its own weight.

Specifically, in the present embodiment, in those cases where the force to be applied to the guide 606 is to be brought to a value as close to 0 as possible to an extent where the carrier 601 will not float from the guide 606, or bearings are to be used as the guide, the force to be applied to each of the bearings is preferably 9.8 N or less. Moreover, in the case where bearings are used as the guide, the force to be applied to each of the bearings may be adjusted within a range of preferably 10 mN to 9.8 N, more preferably 10 mN to 5 N, and most preferably 10 mN to 1.5 N.

Moreover, in terms of the magnetic attraction force with respect to the carrier 601, in the present embodiment, for example, 5 to 99% of the weight of the carrier may be supported by the magnetic attraction force of the linear motor that is provided on the side surface, and the remaining weight may be supported on the bearings (guide) 606. In terms of enabling carrier transportation at an even faster speed, the embodiment illustrated in FIG. 10A and FIG. 10B, in which 100% of the weight of the carrier is supported by the magnetic attraction force of the linear motor, is theoretically preferable. However, in view of a practical application, in those cases where it is difficult to employ a structure in which all of the weight of the carrier is to be supported by the magnetic attraction force of the linear motor, it is, for example, preferable that 70 to 98% of the weight of the carrier be supported by the magnetic attraction force of the linear motor and the remaining 2 to 30% of the weight of the carrier be supported on the guide such as bearings. Furthermore, it is more preferable that 80 to 98% of the weight of the carrier be supported by the magnetic attraction force of the linear motor, and the remaining 2 to 20% of the weight be supported on the guide. However, as can be seen in the embodiment illustrated in FIG. 10A and FIG. 10B, in those cases of employing a configuration in which 100% of the weight of the carrier is to be supported by the magnetic attraction force of the linear motor, naturally these ranges do not need to be considered. However, in the case of considering a guide for supporting the carrier of the present invention, it is preferable that 70 to 100% (more preferably 80 to 100%) of the weight of the carrier be supported by the magnetic attraction force of the linear motor.

Moreover, the magnetic attraction force required for the linear motor (the magnetic attraction force of the linear motor magnets) is to be determined upon consideration of the specific configuration of the apparatus including; whether the linear motor is to function as a member that supports the carrier against falling under its own weight, how much the carrier weighs in this case, and further, what proportion of the weight of the carrier is to be supported by the linear motor, and it is not particularly limited.

Here, in the present embodiment, in a case where the carrier is transported with a large amount of load being applied to the guide such as bearings, the speed of carrier transportation is highly dependent on the on-load characteristics of sliding and rotation of the bearings. As mentioned above, use of a liquid lubricating agent or the like for increasing the sliding characteristic and rotation characteristic is not preferable for bearings to be used in an apparatus such as the magnetic recording medium manufacturing apparatus in which a high level of vacuum is required, and furthermore, there are restrictions on a lubricating agent that may be used therefor. Accordingly, in those cases where the carrier is transported while the majority of the carrier weight is to be supported on the bearings or the like, high speed carrier transportation tends to become difficult. Specifically, according to an analysis conducted by the present inventors, it has been revealed that a transporting time of approximately 0.5 seconds or less can be realized when a carrier which weighs several kilograms is transported a distance of approximately 1.5 m, if the force to be applied to each of the bearings that support the carrier is made 9.8 N (1 kgf) or less.

In the manufacturing apparatus of the present embodiment, the majority of the weight of the carrier 601 is supported by the magnetic attraction force of the linear motor used on the side surface thereof. Therefore the resistance of the guide when transporting the carrier is eliminated and it is possible to move the carrier at high speed.

The “guide that supports the carrier against falling under its own weight” of the present invention means a guide such as the bearings that support the carrier against falling under its own weight when transporting the carrier and when it is in a stand-by state inside the film formation chamber. That is to say, provided this is a bearing or the like having such a function, then in addition to the bearings provided in the lower section of the carrier, this also includes bearings that upwardly support a guide rail where the guide rail is provided on the side section of the carrier. Bearings having this type of function may be provided in the lower section of the carrier, and may be provided on the side section or upper section of the carrier in some cases.

In FIG. 11A and FIG. 11B, the plurality of bearings 606 provided in the lower section of the carrier 601 correspond to the “guide that supports the carrier against falling under its own weight” of the present invention. Moreover, as described above, when the “guide that supports the carrier” is mentioned in the present invention, it may include both the plurality of bearings 606 in the embodiment illustrated in FIG. 10A and FIG. 10B and the plurality of bearings 606 in the embodiment illustrated in FIG. 11A and FIG. 11B.

Moreover, the embodiment illustrated in FIG. 10A and FIG. 10B and the embodiment illustrated in FIG. 11A and FIG. 11B have been described separately in order to facilitate understanding of the function of the guide that supports the carrier of the present invention. However, the present invention is not limited to an apparatus that realizes only either one of the embodiments. In the present invention, specifically, it is possible to construct an apparatus in which both of the embodiments can be appropriately selected, by providing a mechanism for controlling the magnetic attraction force of the linear motor with respect to the carrier, and a control mechanism capable of adjusting the relative positional relationship between the carrier and the guide that supports the carrier according to the magnetic attraction force of the linear motor.

The linear motor driving system in the magnetic recording medium manufacturing apparatus of the present invention, for example, has the linear motor driving electromagnets 801, which are divided into several pieces, as illustrated in FIG. 8. However, it is preferable that these linear motor driving electromagnets 801 be covered by an electromagnet cover 701 as illustrated in FIG. 7, and the electromagnets be provided on the atmosphere side of the side wall section 603 of the film formation chamber.

The linear motor driving electromagnets 801 are electromagnets with electrical wires wound on a magnetic core in a coil shape. However in many cases, the magnetic core and electrical wires are not the type of members to use in a vacuum condition. Moreover the insulation coating of the electrical wires uses a resin or the like, and in many cases should not be used in a vacuum condition. In the magnetic recording medium manufacturing apparatus of the present invention, it is possible to easily provide this type of member outside (on the atmosphere side of) the film formation chamber, and a high level of vacuum inside the film formation chamber can be easily achieved. Also, it is preferable that the electromagnet cover 701 be made thin in order to minimize the distance between the linear motor driving electromagnets 801 and the linear motor driving magnetic material 604. Moreover, as for the material thereof, use of a non-magnetic material, through which a magnetic field can easily pass, is preferred.

Moreover, the film chamber is a vacuum container, and therefore this type of vacuum container receives a considerably high level of external pressure (differential pressure with respect to the atmospheric pressure) applied thereto. Therefore, in those cases where the linear motor driving electromagnets 801 are provided on the atmosphere side of the film formation chamber, it is preferable that between the magnetic material of the carrier and the linear motor driving electromagnets, the member that separates the vacuum side and the atmosphere side be composed of a non-magnetic material tolerant to external pressure. As an example of this type of non-magnetic material, a non-magnetic stainless steel plate with 3 mm thickness may be used.

In the present invention, a permanent magnet is preferably used as the linear motor driving magnetic material 604. The linear motor driving magnetic material 604 responds to the S pole, N pole, and high-speed changes in demagnetization of the linear motor driving electromagnets 801 so as to stop (support) the carrier and move it to the right and left. As the linear motor driving magnetic material, magnetic materials such as iron and cobalt, which are attracted to electromagnets, may be used. However, use of permanent magnets having an attraction force and repulsive force with respect to the electromagnets is preferable in order to ensure even higher speed response of the linear motor driving electromagnets. As permanent magnets that may be used as the linear motor driving magnetic material of the present invention, it is preferable to use ferrite magnets, rare earth magnets, or the like. Among these, ferrite magnets can be easily processed and have a high level of toughness, and therefore, have an advantage in that they can be easily held on a portion on the carrier with screws or the like. Moreover, rare earth magnets cannot be easily processed and are fragile. However, the level of attraction force and repulsive force thereof with respect to electromagnets is high, and therefore, they are capable of moving the carrier at an even higher speed when driving with a linear motor. Rare earth magnets cannot be easily held on a position on the carrier with screws or the like. Therefore it is preferable that the surface thereof be covered with a non-magnetic material such as stainless plate and be of a structure in which the magnets are embedded inside the carrier. As the linear motor driving magnetic material of the present invention, use of a SmCo based or NdFeB based sintered magnet is preferred in terms of the attraction force and repulsive force thereof.

In the magnetic recording medium manufacturing apparatus of the present invention, it is preferable that the carrier 601 be manufactured with use of an aluminum alloy. An aluminum alloy is light weight and hence braking can be easily performed with a linear motor, and also it is a non-magnetic material. Therefore, it is convenient to attach the linear motor driving magnetic material thereto to thereby perform braking. In addition, an aluminum alloy has a low level of degassing in vacuum, and it is therefore convenient for maintaining a high vacuum inside the film formation chamber. However, abrasion resistance is low in aluminum alloy. Therefore use of a highly rigid stainless material or the like having a smooth surface is preferable in the location 903 in FIG. 10B or FIG. 11B where the carrier 601 and the transporting bearings 605 come in contact with each other.

In the magnetic recording medium manufacturing apparatus of the present invention, as described above, the driving mechanism section of the carrier can be provided on the side section of the film formation chamber, and consequently the carrier driving mechanism, which was present in the lower section of the film formation chamber, can be eliminated, thereby increasing the evacuating capacity of the vacuum pump provided in the lower section of the film formation chamber and also enabling speedy evacuation of the film formation chamber. Moreover, a rotating mechanism for magnets, which was needed in the conventional carrier driving mechanism, is no longer required. Furthermore, these mechanisms do not need to be provided inside the film formation chamber, and degassing or leakage from these mechanisms are eliminated. Therefore, it becomes possible to lower the base pressure in the film formation chamber.

Thus a characteristic of the magnetic recording medium manufacturing apparatus of the present invention is that it is particularly superior for forming the magnetic film of a magnetic recording medium with use of a reactive sputtering technique.

### WORKING EXAMPLES

Hereunder, the magnetic recording medium manufacturing apparatus and the magnetic recording medium manufacturing method of the present invention are described, using working examples. However, the present invention is not limited solely to these examples.

### Example 1

### Sputtering Film Formation Manufacturing Apparatus

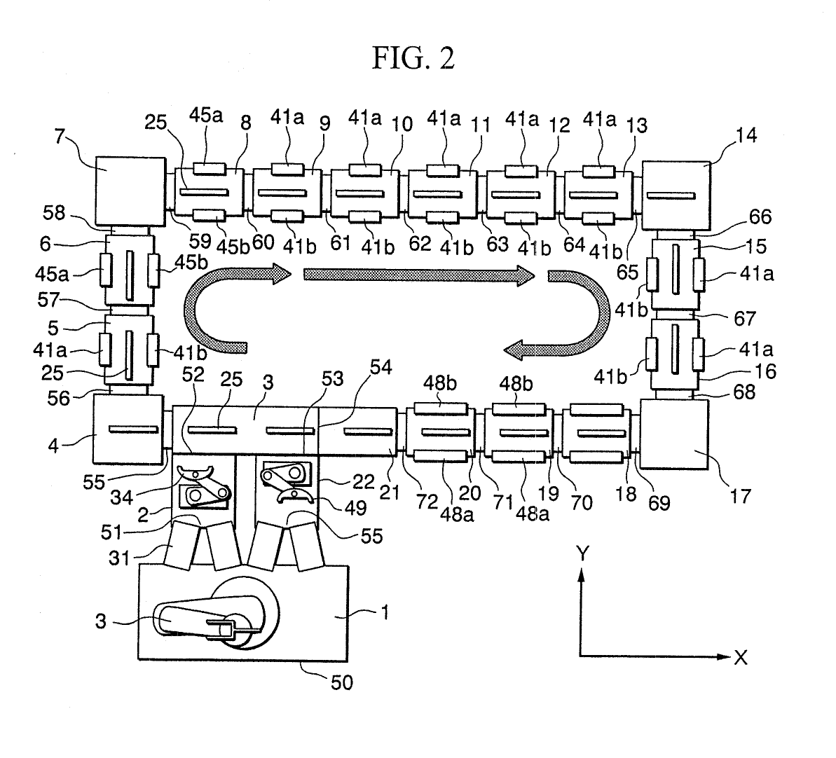

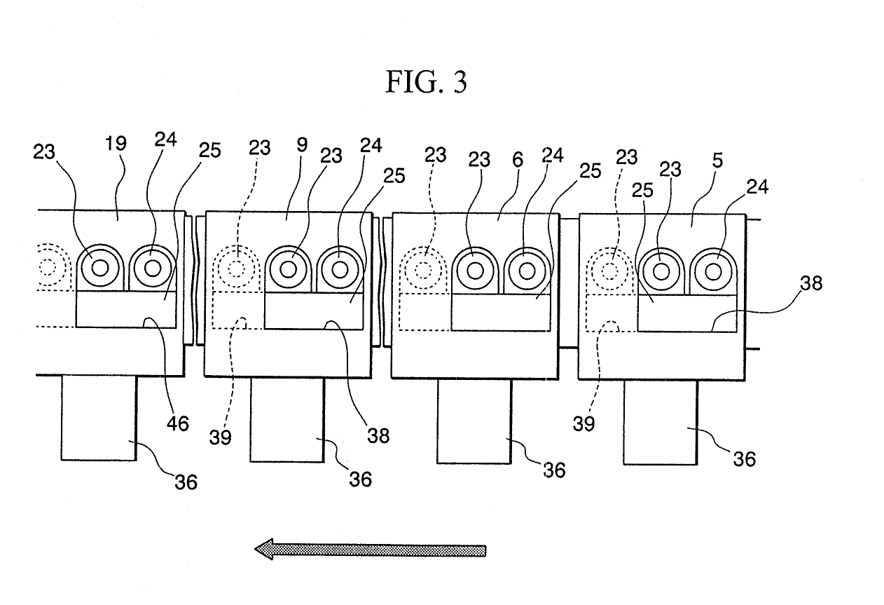

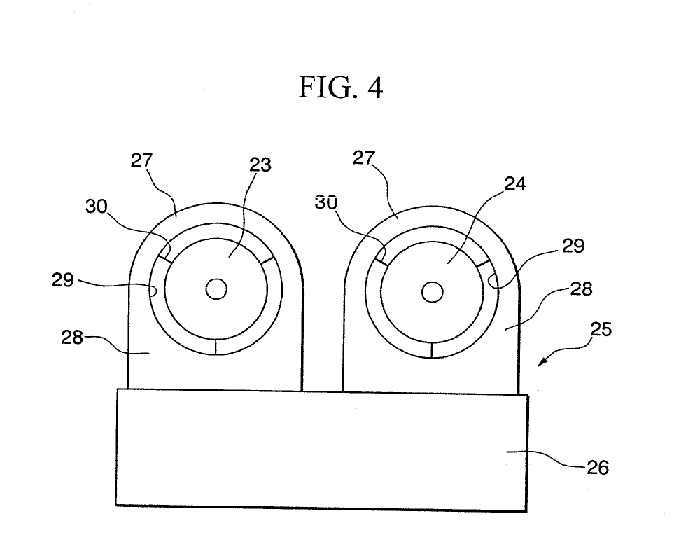

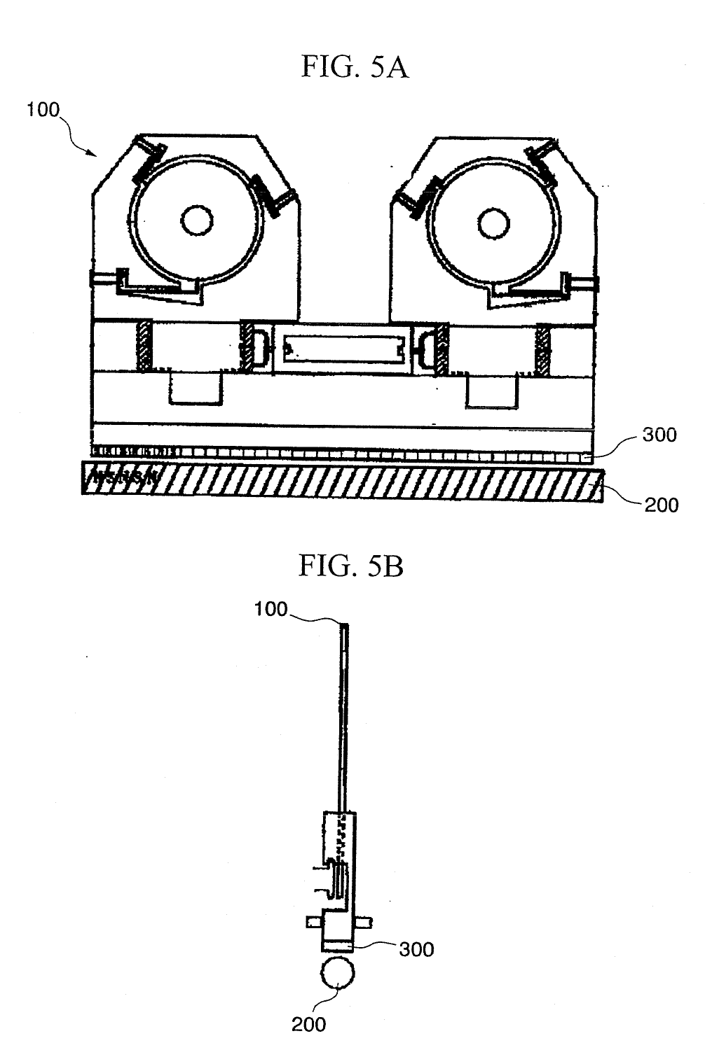

As a magnetic recording medium manufacturing apparatus, there was provided a structure of film formation chambers and so forth illustrated in FIG. 2, basic structures illustrated in FIG. 6 to FIG. 9A and FIG. 9B were used as a carrier and a carrier transporting mechanism, and between the carrier lower section and bearings, there was provided an approximately 5 mm clearance as illustrated in FIG. 10A and FIG. 10B. The carrier was fabricated with an A5052 aluminum alloy, an NdFeB based sintered permanent magnet was embedded on the side surface of the carrier, and the surface thereof was covered with a plate of SUS304 with 0.5 mm thickness. On the film formation chamber side wall distanced from the surface by 0.5 mm, there was provided a linear motor electromagnet covered with a cover of SUS304 with 1 mm thickness. The linear motor electromagnet was provided outside (on the atmosphere side of) the reaction chamber. As the linear motor electromagnet, there was used an SGL series electromagnet with a magnetic attraction force of 2,000 N manufactured by Yasukawa Electric Corporation.

In the present apparatus, five bearings were provided as a guide in the lower section of the carrier. However, as described above, a clearance was provided between these members, and therefore the force to be applied to each of the bearings was 0. That is to say, the present apparatus employed a structure in which the magnetic attraction force of the linear motor provided in the side surface direction of the carrier completely supports the carrier against falling under its own weight. Therefore, the bearings provided in the lower section of the carrier were not members that support the carrier against falling under its own weight, and were to function as members for preventing incidental vibrations of the carrier.

In the magnetic recording medium manufacturing apparatus of this structure, the speed of moving the carrier between the film formation chambers at approximately 1.5 m intervals, reached 0.3 seconds or less, including the time for accelerating and decelerating the carrier.

### (Manufacturing a Magnetic Recording Medium Using Reactive Sputtering)

A non-magnetic substrate composed of a NiP-plated aluminum substrate was supplied to the film formation chamber of a sputtering film formation apparatus using a substrate transport device, and the inside of the film formation chamber was then evacuated. The base pressure within the film formation chamber reached 1×10⁻⁸ Pa in a short period of time. Having completed evacuation, the substrate was mounted on a carrier in a vacuum environment of the film formation chamber, using the substrate transport device. The configuration of the films to be formed on the substrate was such that a 10 nm Cr film was formed as an adhesive layer, and a 30 nm film of 70Co-20Fe-5Ta-5Zr, a 0.8 nm Ru film, and a 30 nm film of 70Co-20Fe-5Ta-5Zr were formed as backing layers. Next, a 5 nm film of 90Ni-10W was formed as an orientation control film, and a 15 nm Ru film was formed as an undercoat film. When conducting sputtering, an Ar gas was used, and the gas pressure for the backing layer and 90Ni-10W was 0.8 Pa, and the gas pressure for the Ru undercoat layer was 8 Pa.

A 12 nm film of 92(66Co-16Cr-18Pt)-8(SiO₂) was formed as a perpendicular magnetic recording layer by means of reactive sputtering. The target composition was 92(66Co-16Cr-18Pt)-8(SiO₂), and a mixed gas, in which raw material gases argon and oxygen were mixed at respective flow rates 200 sccm and 50 sccm, was released from a ring-shaped gas release tube provided around the target having 20 of 1 mm fine holes provided at equal intervals in the inward direction. The pressure inside the container when conducting the reactive sputtering was 1×10⁻¹ Pa. Two turbo molecular pumps were provided on the upper section and one turbo molecular pump was provided on the lower section of this reactive sputtering apparatus, and when conducting the film formation, the reactive gas was evacuated in the upper section and lower section respectively at 600 l/sec and 350 l/sec of total effective evacuation speed.

Next, the substrate was transferred to a CVD film formation apparatus, and a 4 nm carbon protective film was formed by means of a CVD method, to thereby manufacture a magnetic recording medium.

### Example 2

### Sputtering Film Formation Manufacturing Apparatus

As a magnetic recording medium manufacturing apparatus, as illustrated in FIG. 11A and FIG. 11B, a sputtering film formation manufacturing apparatus was constructed as with the case of Example 1, except that it employed a structure in which the lower section of the carrier and five bearings provided as a guide were steadily in contact with each other.

In this apparatus, five bearings were provided in the lower section of the carrier as a guide, and the forced applied to each of the bearings was approximately 100 gf (980 mN) with respect to the weight of the carrier 8 kg. As a result, in this apparatus, approximately 95% of the carrier weight was supported by the magnetic attraction force of the linear motor from the side surface thereof, and the remaining 5% of the weight was supported on the bearings.

### (Manufacturing a Magnetic Recording Medium Using Reactive Sputtering)

A magnetic recording medium was manufactured as with Example 1, using this manufacturing apparatus.

A lubricating agent was coated on each of the 100 magnetic recording media obtained in Examples 1 and 2, and then the recording/reproduction characteristics of these media were evaluated using a read/write analyzer 1632 and a spin-stand S1701MP, manufactured by Guzik Co., USA. As recording/reproduction characteristics, signal-to-noise ratios (SNR where S is an output value at a line recording density of 576 kFCI, and N is an rms (root-mean-square) value at a line recording density of 576 kFCI) and OW values (a reproduction output ratio (attenuation rate) of signals of 576 kFCI before and after the signal at a line recording density of 77 kFCI was overwritten, after having recorded a signal at a line recording density of 576 kFCI) were evaluated. As a result, it was discovered that in either case of using the manufacturing apparatus of Example 1 or Example 2, a magnetic recording medium can be obtained with stable characteristics in which variation in SNR on a magnetic recording medium surface was within a range of 5% and variation in OW values was within a range of 3%.

### INDUSTRIAL APPLICABILITY

The magnetic recording medium manufacturing apparatus and magnetic recording medium manufacturing method of the present invention have a high level of industrial applicability in fields such as information processing technology.

1. A magnetic recording medium manufacturing apparatus comprising: a plurality of connected film formation chambers, a carrier that holds a substrate, a mechanism for mounting a pre-film-formation substrate on the carrier, a mechanism for sequentially transporting the carrier into the plurality of connected film formation chambers, and a mechanism for removing a post-film-formation substrate from the carrier, wherein said mechanism for transporting the carrier is a linear motor.

2. The magnetic recording medium manufacturing apparatus according to claim 1, wherein a magnetic material is provided on a side section of the carrier, and the carrier is transported by a linear motor that is provided on a wall section of the film formation chamber so as to oppose to the magnetic material.

3. The magnetic recording medium manufacturing apparatus according to claim 1, wherein said linear motor has a function of supporting the carrier against falling under its own weight, and a guide that supports the carrier against falling under its own weight is provided inside the film formation chamber.

4. The magnetic recording medium manufacturing apparatus according to claim 3, wherein the guide provided in said film formation chamber that supports the carrier against falling under its own weight is a plurality of bearings.

5. The magnetic recording medium manufacturing apparatus according to claim 4, wherein a force applied to each of said bearings is 9.8 N or less.

6. The magnetic recording medium manufacturing apparatus according to claim 2, wherein the magnetic material provided on the side section of said carrier is a permanent magnet.

7. The magnetic recording medium manufacturing apparatus according to claim 1, wherein an electromagnet of the linear motor is provided on an atmosphere side of the film formation chamber.

8. A magnetic recording medium manufacturing method, wherein at least a magnetic film is formed on the surface of a substrate by using the magnetic recording medium manufacturing apparatus according to claim 1.
